(19) United States
(12) Patent Application Publication
(10) Pub. No.: US 2006/0042314 A1
(43) Pub. Date: Mar. 2, 2006

(54) Noncontact glass sheet stabilization device used in fusion forming of a glass sheet

(76) Inventors: John S. Abbott III, Elmira, NY (US); Chester H. Chang, Painted Post, NY (US); Thierry L.A. Dannoux, Avon (FR); Keith L. House, Corning, NY (US); Michael Y. Nishimoto, Painted Post, NY (US); Alexander L. Robinson, Elmira, NY (US); G. Clinton Shay, Moneta, VA (US)

Correspondence Address: CORNING INCORPORATED, SP-TI-3-1, CORNING, NY, 14831, US

(21) Appl. No.: 10/928,032

(22) Filed: Aug. 27, 2004

(51) Int. Cl. C03B 35/24; C03B 40/02

(52) U.S. Cl. 65/25.3; 65/182.2; 65/195; 65/53; 65/29.18; 65/158; 65/160

(57) ABSTRACT

A noncontact glass sheet stabilization device is described herein that is capable of reducing translation (deflection) and/or rotational movement of a glass sheet while the glass sheet is being manufactured in a glass manufacturing system that implements a fusion process. Several different embodiments of the noncontact glass sheet stabilization device are also described herein.

### BACKGROUND OF THE INVENTION

1. Field of the Invention

The present invention relates to a noncontact glass sheet stabilization device that reduces translational (deflection) movement, rotational movement, or both translational and rotational movement of a glass sheet without physically contacting the glass sheet while the glass sheet is being made in accordance with a fusion process in a glass manufacturing system. It should be noted that the noncontact glass sheet stabilization device can also be used in other applications like in a measurement system or an inspection system.

2. Description of Related Art

Corning Incorporated has developed a process known as the fusion process (e.g., downdraw process) to form high quality thin glass sheets that can be used in a variety of devices like flat panel displays. The fusion process is the preferred technique for producing glass sheets used in flat panel displays because the glass sheets produced by this process have surfaces with superior flatness and smoothness when compared to glass sheets produced by other methods. The fusion process is described in U.S. Pat. Nos. 3,338,696 and 3,682,609, the contents of which are incorporated herein by reference.

In the fusion process, a fusion draw machine (FDM) is used to form a glass sheet and then draw the glass sheet between two rolls to stretch the glass sheet to a desired thickness. Then a traveling anvil machine (TAM) is used to cut the glass sheet into smaller glass sheets that are sent to customers. It has been found that the movement of the glass sheet between the FDM and TAM is a cause of stress (warp) in the glass sheet. It has also been found that the glass sheet is further stressed because it moves when it is cut by the TAM. There are several problems that can occur whenever the glass sheet is stressed. For example, a stressed glass sheet can distort more than 2 microns which is not a desirable situation for the customers. As another example, a large glass sheet may be stressed yet undistorted but then distort when it is cut into smaller glass sheets.

As such, there has been a lot of work by the manufacturers of glass sheets like Corning Incorporated to develop devices that can help minimize the movement of the glass sheet between the FDM and TAM which in turn would reduce the creation of problematical stress in the glass sheet. It is well known that the mechanical devices which touch the pristine surface of the glass sheet cannot be used since physical contact of the glass sheet can damage the glass sheet. Accordingly, there is a need for a device that helps prevent the movement of the glass sheet without contacting the pristine surface of the glass sheet. This need and other needs are satisfied by the noncontact glass sheet stabilization device of the present invention.

### BRIEF DESCRIPTION OF THE INVENTION

The present invention includes a noncontact glass sheet stabilization device and method that helps minimize the movement of a glass sheet. In the preferred embodiment, the noncontact glass sheet stabilization device is capable of reducing the translation and/or rotational movement of a glass sheet without physically contacting the glass sheet. One preferred application for the noncontact glass sheet stabilization device is where the glass sheet is being manufactured in a glass manufacturing system that implements a fusion draw process. Several different embodiments of the noncontact glass sheet stabilization device are described herein.

### BRIEF DESCRIPTION OF THE DRAWINGS

A more complete understanding of the present invention may be had by reference to the following detailed description when taken in conjunction with the accompanying drawings wherein:

FIG. 1 is a block diagram illustrating an exemplary glass manufacturing system incorporating a noncontact glass sheet stabilization device configured in accordance with the present invention;

FIGS. 2A-2Q are several diagrams associated with a first embodiment of the noncontact glass sheet stabilization device which utilizes a float chuck to minimize the movement of the glass sheet between a FDM and a TAM as shown in FIG. 1;

FIGS. 3A-3C are several diagrams associated with a second embodiment of the noncontact glass sheet stabilization device which utilizes one or more air jets to minimize the movement of the glass sheet between the FDM and the TAM as shown in FIG. 1;

FIG. 4 is a block diagram associated a third embodiment of the noncontact glass sheet stabilization device which utilizes one or more air bearings to minimize the movement of the glass sheet between the FDM and the TAM as shown in FIG. 1;

FIGS. 5A-5I are several diagrams associated a fourth embodiment of the noncontact glass sheet stabilization device which utilizes one or more air cushions/pads to minimize the movement of the glass sheet between the FDM and the TAM as shown in FIG. 1;

FIG. 6 is a block diagram of a fifth embodiment of the noncontact glass sheet stabilization device which utilizes one or more corona charging devices to minimize the movement of the glass sheet between the FDM and the TAM as shown in FIG. 1;

FIG. 7 is a block diagram of a sixth embodiment of the noncontact glass sheet stabilization device which utilizes an induced electrostatic stabilizer to minimize the movement of the glass sheet between the FDM and the TAM as shown in FIG. 1;

FIG. 8 is a block diagram of an seventh embodiment of the noncontact glass sheet stabilization device which utilizes at least one plate/air inlet valve to minimize the movement of the glass sheet between the FDM and the TAM as shown in FIG. 1;

FIG. 9 is a block diagram of an eighth embodiment of the noncontact glass sheet stabilization device which utilizes one or more moveable plates to minimize the movement of the glass sheet between the FDM and the TAM as shown in FIG. 1;

FIG. 10 is a block diagram of a ninth embodiment of the noncontact glass sheet stabilization device which utilizes thermally controlled plates to minimize the movement of the glass sheet between the FDM and the TAM as shown in FIG. 1; and

FIG. 11 is a flowchart illustrating the basic steps of a preferred method for producing a glass sheet using the noncontact glass sheet stabilization device shown in FIG. 1 in accordance with the present invention.

### DETAILED DESCRIPTION OF THE DRAWINGS

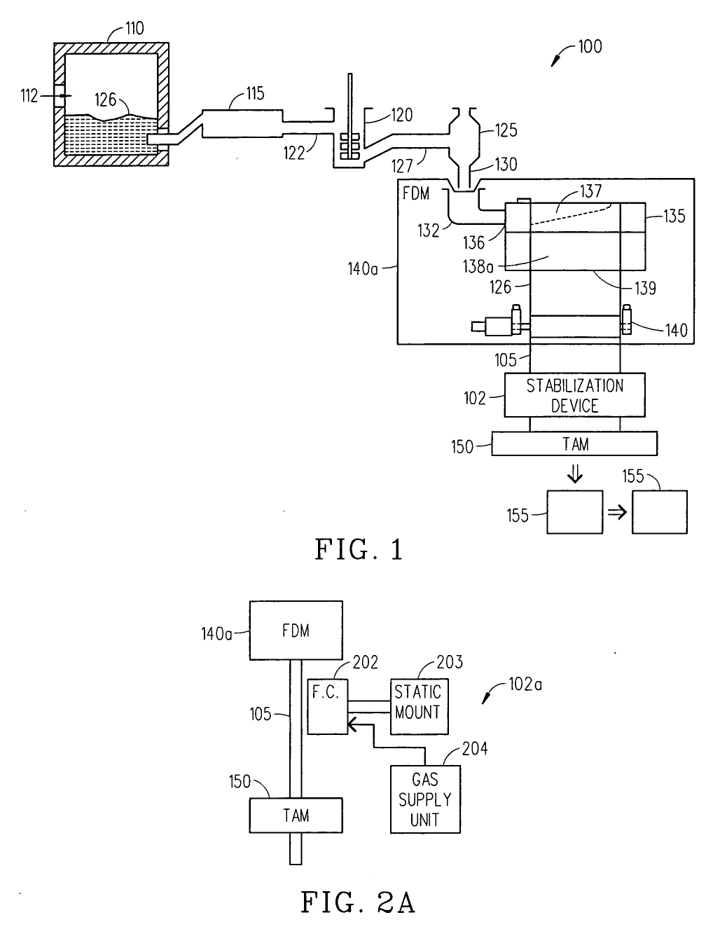

Referring to FIGS. 1-11, there are disclosed several embodiments of a noncontact glass sheet stabilization device 102 and a method 1100 for producing a glass sheet 105 using the noncontact glass sheet stabilization device 102 in accordance with the present invention. Although the noncontact glass sheet stabilization device 102 hereinafter called the stabilization device 102 is described below as being used in a glass manufacturing system 100 that uses a fusion process to make a glass sheet 105, it should be understood that the stabilization device 102 could be used in any type of glass manufacturing system that draws molten glass to make a glass sheet 105. It should also be understood that the noncontact glass sheet stabilization device can also be used in other applications like in a measurement system and an inspection system. Accordingly, the stabilization device 102 and method 1100 of the present invention should not be construed in a limited manner.

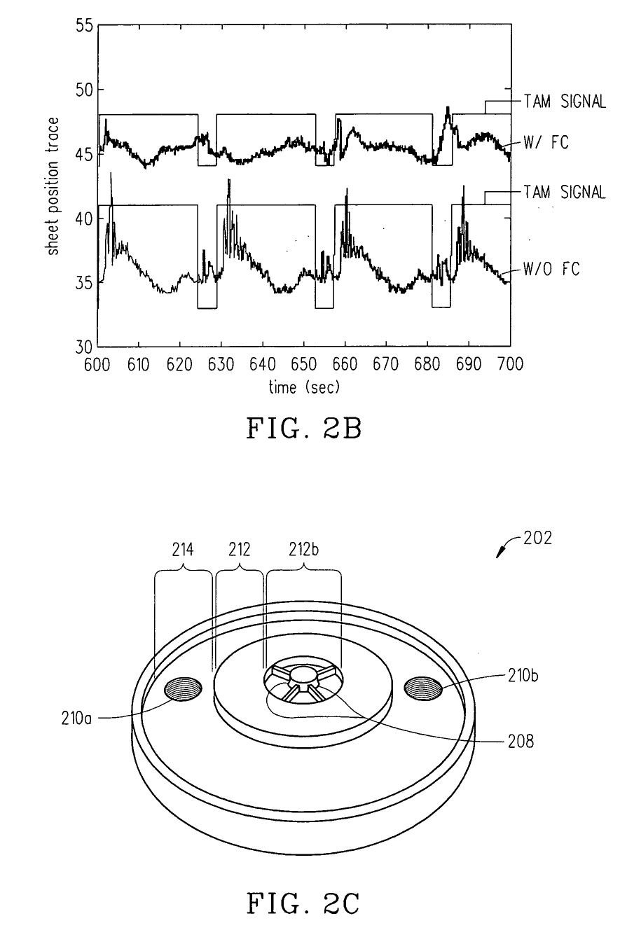

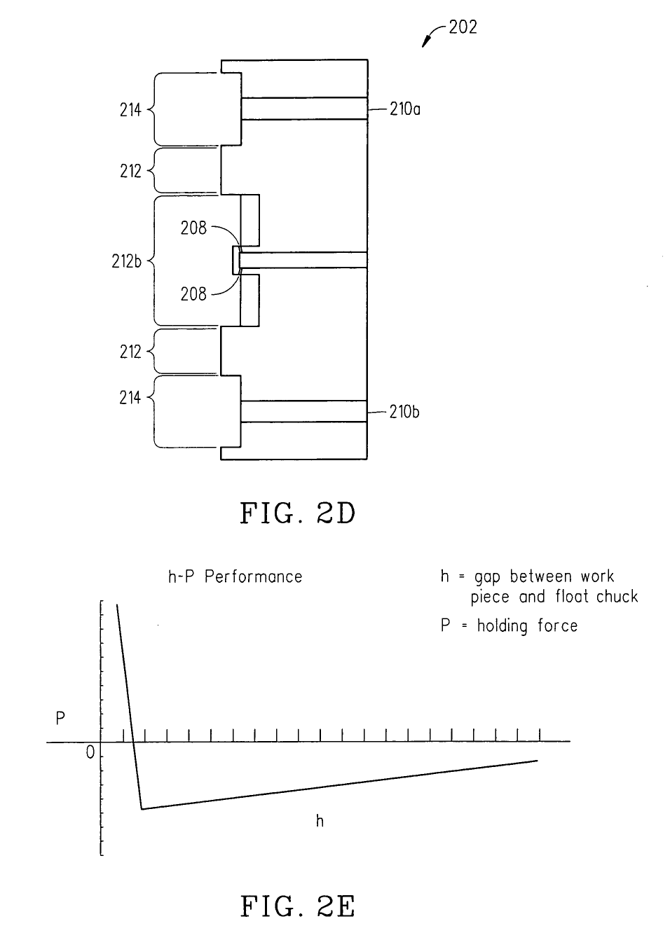

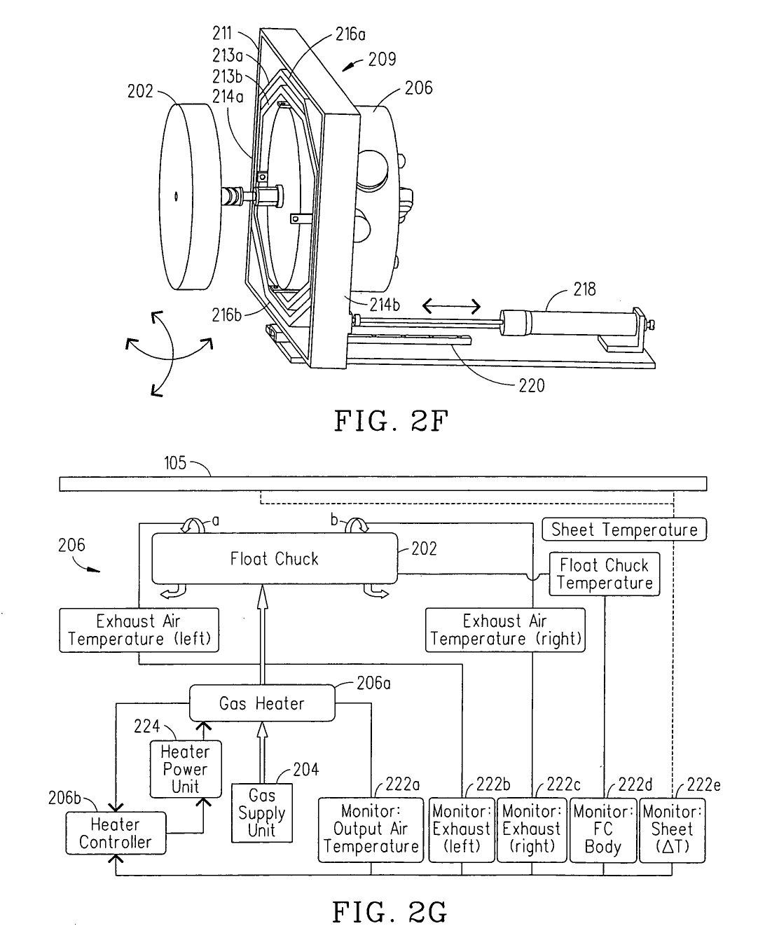

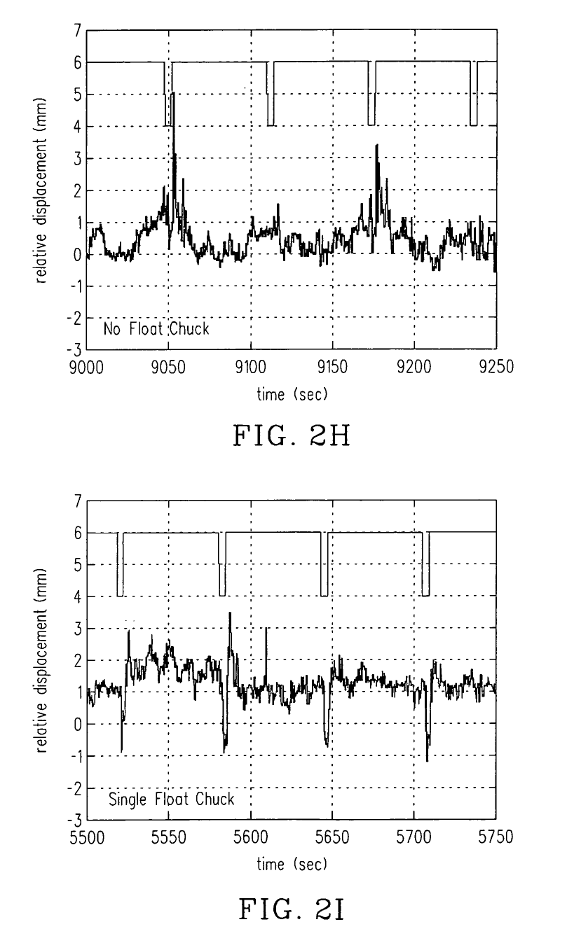

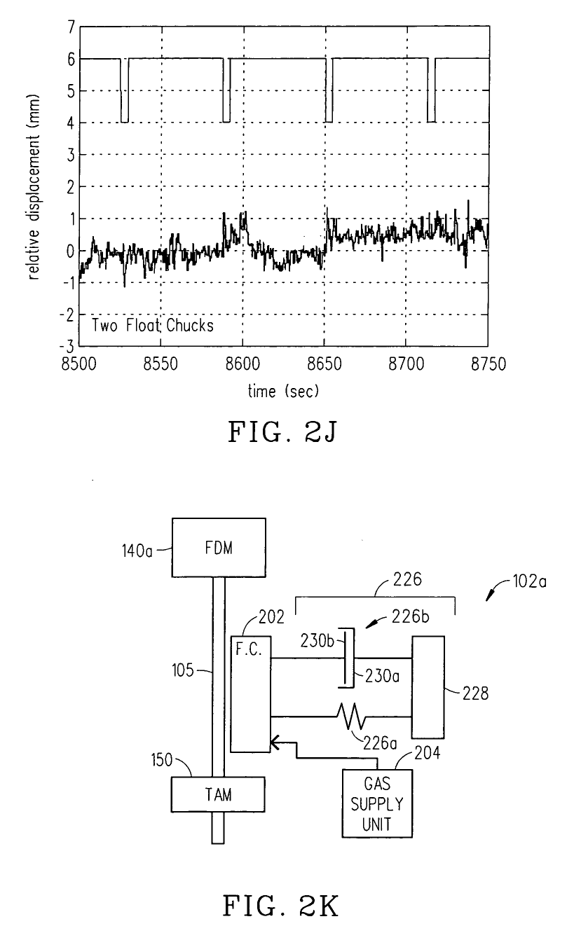

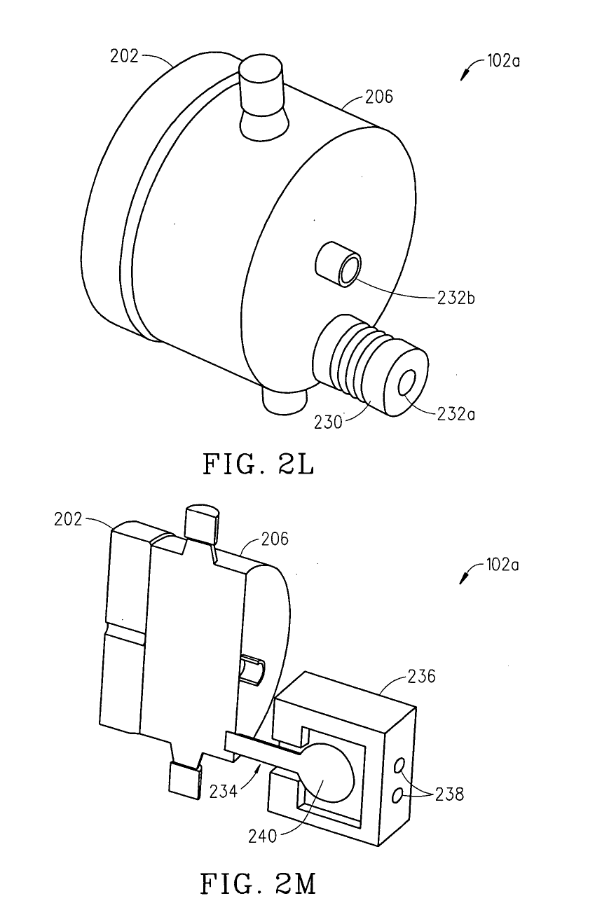

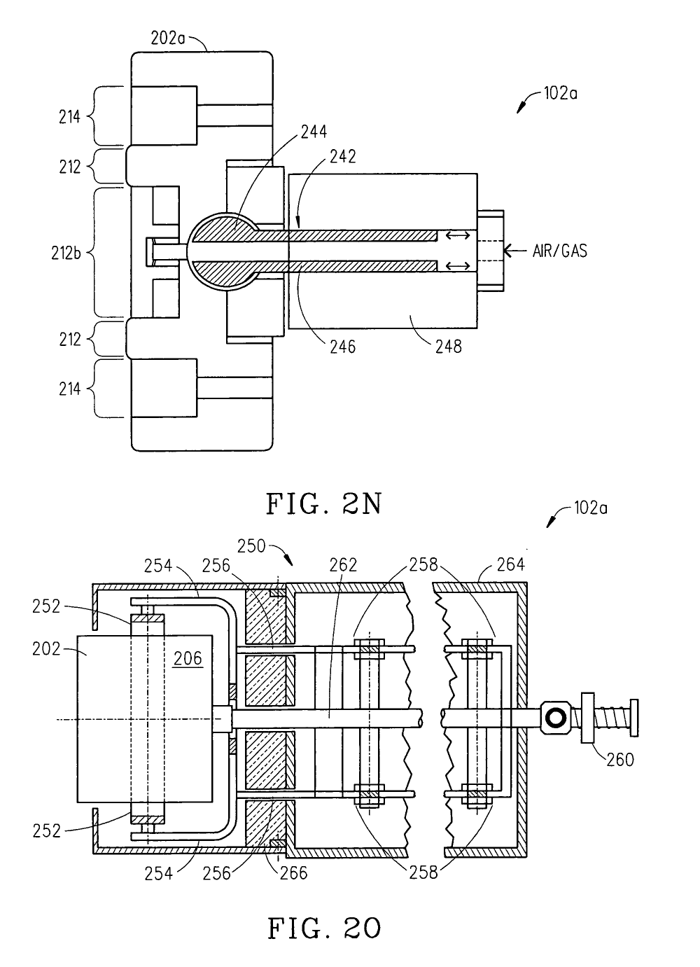

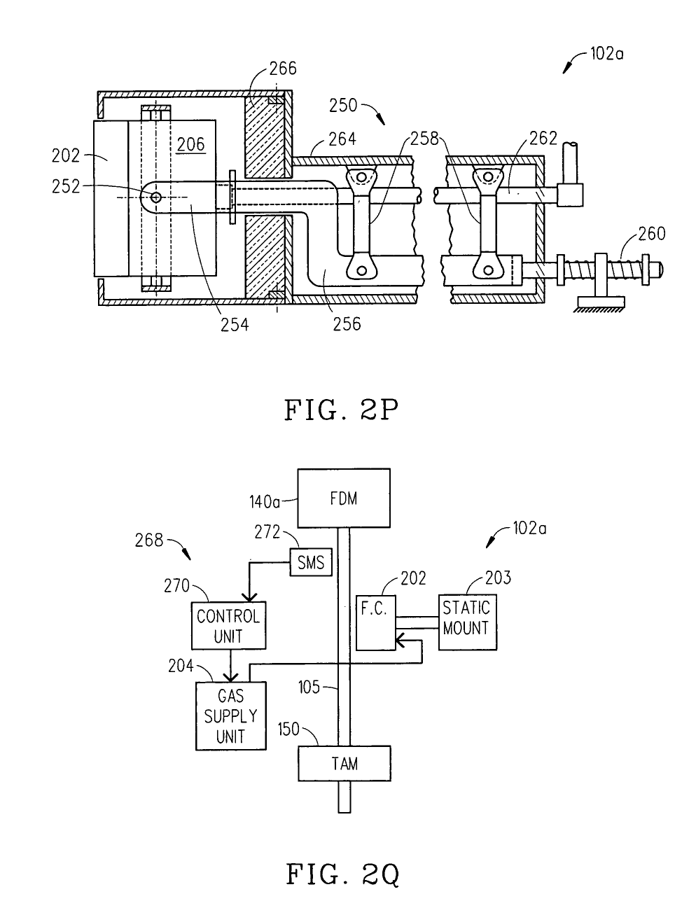

Referring to FIG. 1, there is shown a schematic view of an exemplary glass manufacturing system 100 that uses the fusion process to make a glass sheet 105. The glass manufacturing system 100 includes a melting vessel 110, a fining vessel 115, a mixing vessel 120 (e.g., stir chamber 120), a delivery vessel 125 (e.g., bowl 125), a fusion draw machine (FDM) 140a, the stabilization device 102 and a traveling anvil machine (TAM) 150. The melting vessel 110 is where the glass batch materials are introduced as shown by arrow 112 and melted to form molten glass 126. The fining vessel 115 (e.g., finer tube 115) has a high temperature processing area that receives the molten glass 126 (not shown at this point) from the melting vessel 110 and in which bubbles are removed from the molten glass 126. The fining vessel 115 is connected to the mixing vessel 120 (e.g., stir chamber 120) by a finer to stir chamber connecting tube 122. And, the mixing vessel 120 is connected to the delivery vessel 125 by a stir chamber to bowl connecting tube 127. The delivery vessel 125 delivers the molten glass 126 through a downcomer 130 into the FDM 140a which includes an inlet 132, a forming vessel 135 (e.g., isopipe 135), and a pull roll assembly 140. As shown, the molten glass 126 from the downcomer 130 flows into an inlet 132 which leads to the forming vessel 135 (e.g., isopipe 135). The forming vessel 135 includes an opening 136 that receives the molten glass 126 which flows into a trough 137 and then overflows and runs down two sides 138a and 138b before fusing together at what is known as a root 139. The root 139 is where the two sides 138a and 138b come together and where the two overflow walls of molten glass 126 rejoin (e.g., refuse) before being drawn downward by the pull roll assembly 140 to form the glass sheet 105. The stabilization device 102 helps prevent the glass sheet 105 located within and below the FDM 140a from moving due to the drawing operation of the FDM 140a. The TAM 150 then cuts the drawn glass sheet 105 into distinct pieces of glass sheets 155. The stabilization device 102 also helps prevent the glass sheet 105 located above the TAM 150 from moving due to the cutting operation of the TAM 150. Several different embodiments of the stabilization device 102 are described in detail below with respect to FIGS. 2-10.

Referring to FIGS. 2A-2Q, there are several diagrams associated with a first embodiment of the stabilization device 102a which utilizes a float chuck 202 (aero-mechanical device 202) to minimize the movement of the glass sheet 105 between the FDM 140a and the TAM 150. As shown in FIG. 2A, the stabilization device 102a includes a gas supply unit 204 and the float chuck 202 which is located on one side of the glass sheet 105 and positioned between the FDM 140a and the TAM 150. The float chuck 202 is also shown attached to a static mount 203. The float chuck 202 is configured such that the gas from the gas supply unit 204 flows thru it in a manner so as to create a gas film on one side of the glass sheet 105 such that if the glass sheet 105 moves too far away from a face of the float chuck 202 then a suction force (Bernoulli suction force) created by gas emitted from the float chuck 202 pulls the glass sheet 105 back to the float chuck 202. And, if the glass sheet 105 moves too close to the face of the float chuck 202 then a repulsive force caused by the gas emitted from the float chuck 202 pushes the glass sheet 105 away from the float chuck 202. It is the balance between the suction force and the repulsion force that enables the float chuck 202 to hold the glass sheet 105 at a given position without having to touch the glass sheet 105. FIG. 2B illustrates a graph that was obtained in an experiment that showed how much the stabilization device 102a shown in FIG. 2A minimizes the movement of the glass sheet 105 within the FDM 140a when compared to a glass manufacturing system that does not utilize the stabilization device 102a. The TAM cycle represents contact between a scoring wheel in the TAM 150 and the glass sheet 105. This cycle occurs once per cut piece of glass sheet 155. In these experiments, a person controlled the temperature of the gas that was emitted from the float chuck 202. A more detailed description about the shape and the functionality of the float chuck 202 is provided below with respect to FIGS. 2C-2E.

As shown in FIGS. 2C-2D, there are respectively illustrated a perspective view of a front side of the float chuck 202 and a cross-sectional side view of the float chuck 202. The float chuck 202 has holes 208 in which the gas is supplied and two holes 210a and 210b through which the gas is exhausted. The float chuck 202 also has a land portion 212, a center portion 212b, and a cavity portion 214. Essentially, the float chuck 202 is configured such that as the gas flows through a small gap between the glass sheet 105 and the face of the float chuck 202 in the land portion 212, it flows faster, increasing the dynamic pressure ρU² where ρ is the gas density and U is the gas velocity. The increase in the dynamic pressure ρU² means that the static pressure P is reduced in accordance with the Bernoulli equation which states P+ρU²=0. It is this reduction in static pressure P which generates a negative pressure or vacuum by which the float chuck 202 can actually grab and hold the glass sheet 105. The center portion 212b holds a volume of pressurized gas introduced through holes 208. This center portion acts as a pressure pad which repels the sheet. The balance between the suction force generated by the land portion 212 and the repelling force generated by the center portion 212b yields a net force upon the glass sheet 105. FIG. 2E illustrates a performance curve of the float chuck 202 wherein the +Y axis is the repelling force, the −Y axis is the attraction force and the X axis is the distance between the float chuck 202 and target (e.g., glass sheet 105). It should be appreciated that there are other configurations that the float chuck 202 can have besides the configuration shown in FIGS. 2C-2D. For a detailed description of some of the possible different configurations of float chucks 202 reference is made to U.S. Pat. No. 5,067,762. The contents of this patent are incorporated by reference herein.

As shown in FIG. 2F, there is illustrated an embodiment of the stabilization device 102a where the float chuck 202 is attached to a gas heater 206 which in turn is attached to both the gas supply unit 204 (not shown), a gas heater controller 206b (see FIG. 2G), and an adaptive mount 209. The adaptive mount 209 is designed to enable the float chuck 202 and the gas heater/gas controller 206 to have three degrees of movement including two-tilt movements and one-translation movement so that the float chuck 202 can self-align and remain parallel with the glass sheet 105 (not shown). The adaptive mount 209 includes a gimbal formed from a rectangular frame 211 which is mounted to two octagonal frames 213a and 213b that can rotate with respect to one another such that the float chuck 202 can tilt around two axes. To enable this, the outer octagonal frame 213a is pivotally attached to two sides 214a and 214b of the rectangular frame 211. And, the inner octagonal frame 213b is pivotally attached to two sides 216a and 216b of the outer octagonal frame 213a. The adaptive mount 209 also includes an air cylinder 218 (air damper 218) which is connected to a linear slide 220 that allows the rectangular frame 211, two octagonal frames 213a and 213b, gas heater 206 and the float chuck 202 to move in 1-translation direction. The damper 218 restricts motion in the 1-translation direction. In operation, the adaptive mount 209 allows the float chuck 202 to self align with the glass sheet 105 in a manner that minimizes the chances for the float chuck 202 to touch the glass sheet 105. It should be noted that the concepts described here can be implemented in many different embodiments. Several different possible modes of operations and/or embodiments of the adaptive mount 209 are described below:

With all three degrees of freedom (2-tilt, 1-translation), the float chuck 202 can self-align with the glass sheet 105 which maximizes the force applied by the float chuck 202 upon the sheet 105 while minimizing the risk of the float chuck 202 touching the glass sheet 105. It also allows the sheet to move to the lowest energy position, that is, the location the glass sheet 105 would naturally attain. Despite low friction motion, this configuration reduces deflection of the glass sheet 105 due to its large inertia. Since the motion of the glass sheet 105 is cyclical, and much motion is due to an impulsive disturbance, the inertia of the float chuck 202 and adaptive mount 209 holding onto the glass sheet 105 reduces the overall range of movement of the glass sheet 105. The air cylinder 218 aids in this as well.

Two tilt degrees of freedom, immovable in translation—still allows the float chuck 202 to remain parallel with glass sheet 105 and hold the glass sheet 105. This mode helps reduce stress in the glass sheet 105 because the glass sheet 105 in the forming region is moving much less.

Use all three degrees of freedom during engagement of multiple float chucks 202 each of which can have an independent suspension to one side of the glass sheet 105. In this mode, the typical procedure would be to engage one float chuck 202 with the glass sheet 105, and then engage another float chuck 202 on the glass sheet 104 and so on. It should be noted that one or more float chuck(s) 202 can be placed on the other side of the glass sheet 105. This is also true for the other embodiments of the stabilization device 102a described herein. This allows initial engagement to the glass sheet 105 with a minimum disturbance to the glass sheet 105. Once the desired number of float chucks 202 are engaged, the various axes of motion can be restricted by damping or locking in place to achieve reduction in sheet motion during steady operation.

After initial engagement with all degrees of freedom, the shape of the glass sheet 105 can be prescribed by moving each float chuck 202 to the desired location, then locking the translation axes in a fixed position. Further determination of the position of the glass sheet 105 can be attained by locking the tilt axes as well.

FIG. 2G illustrates the different components associated with a preferred embodiment of the gas heater/gas controller 206 shown in FIG. 2F. It should be noted that the controller for the gas heater could be housed in a location separate from the gas heater itself and connected via a variety of means including wiring, a radio frequency wireless connection, or infra-red (IR) wireless communication. As shown, the gas heater/gas controller 206 operates to heat the gas emitted from the gas supply unit 204 such that the heated gas (see labels “a” and “b”) emitted from the float chuck 202 towards the glass sheet 105 has substantially the same temperature as the glass sheet 105. To accomplish this, the gas heater/gas controller 206 can utilize some or all of multiple sensors 222a, 222b, 222c, 222d and 222e to measure and monitor the temperatures of the gas heater 206a, the left exhaust gas “a”, the right exhaust gas “b”, the float chuck 202 and the glass sheet 105, respectively. The heater controller 206b analyzes some or all of these temperatures and controls a heater power unit 224 that provides the power (electricity) used to heat the gas in the gas heater 206a. It should be appreciated that the gas heater/gas controller 206 or a similar device can be incorporated within and used by any of the stabilization devices 102a shown in FIGS. 2A-2Q. FIGS. 2H-2J illustrate three graphs that were obtained in an experiment that shows how a stabilization device 102a similar to the one shown in FIGS. 2F-2G can minimize the movement of the glass sheet 105 between the FDM 140a and the TAM 150. It should be noted that the graph associated with FIG. 2H was generated in an experiment that did not use the stabilization device 102a. And, the graph associated with FIG. 2J was generated with a stabilization device 102a that utilized two float chucks 202 positioned on the same side at ⅓^{rd} and ⅔^{rd} distance across the width of the glass sheet 105 (not shown).

As shown in FIG. 2K, there is illustrated another embodiment of the stabilization device 102a where the float chuck 202 is supported by a spring/damper system 226 instead of by a static mount 203 (see FIG. 2A) or an adaptive mount 209 (see FIG. 2F). The spring/damper system 226 includes a spring 226a which is attached at one end to the float chuck 202 and at another end to a static mount 228. In addition, the spring/damper system 226 includes a damper 226b (dashpot 226b) that has a fixed part 230a which is attached to the static mount 228 and a moveable part 230b which is attached to the float chuck 202. In operation, the spring/damper system 226 helps “dampen” the motion of the glass sheet 105 rather than “constrain” the motion of the glass sheet 105 as shown in the embodiment depicted in FIG. 2A. It should be appreciated that this stabilization device 102a can also incorporate the gas heater/gas controller 206 shown in FIG. 2G which would also be connected between the spring/damper system 226 and float chuck 202. Alternatively, the gas heater 206 could be attached directly to static mount 228 and connected through a flexible coupling to the float chuck 202 without altering its function. It should also be appreciated that to avoid repetition, the different components associated with the stabilization device 102a like the FDM 140, the TAM 150 and gas supply unit 204 are not described again since they have already been described above with respect to FIGS. 1 and 2A.

As shown in FIG. 2L, there is illustrated yet another embodiment of the stabilization device 102a where the float chuck 202 and the gas heater/gas controller 206 are supported by a flexible coupling 230. The flexible coupling 230 enables the float chuck 202 and the gas heater/gas controller 206 to have 2 axes of movement. The float chuck 202 and the gas heater/gas controller 206 may also be connected to an air cylinder/damper 218 and a linear slide 220 that moves both the float chuck 202 and gas heater/gas controller 206 in 1-translation direction (see FIG. 2H). The flexible coupling 230 can also have a hole 232a that is connected to the gas supply unit 204 (see FIG. 2A). Alternatively, the gas supply unit 204 can be connected to coupling/hole 232b.

As shown in FIG. 2M, there is illustrated still yet another embodiment of the stabilization device 102a where the float chuck 202 and the gas heater/gas controller 206 are supported by a spherical joint 234. The spherical joint 234 is supported in a 2-two part housing 236 (only half of the housing 236 is shown) that has one or more vacuum/air ports 238 (two shown). The vacuum/air ports 238 are connected to an air supply (not shown) which can provide an air bearing for the ball portion 240 of the spherical joint 234 that enables the float chuck 202 and the gas heater/gas controller 206 to have 2 axis of movement. The spherical joint 234 can also be locked in place if the air supply (not shown) applies a vacuum within the housing 236. The spherical joint housing 236 may also be connected to an air cylinder/damper 218 and a linear slide 220 that moves both the float chuck 202 and gas heater/gas controller 206 in 1-translation direction (see FIG. 2F). This adds one axis of translation to the motion of float chuck 202 and gas heater 206.

As shown in FIG. 2N, there is illustrated yet another embodiment of the stabilization device 102a where the float chuck 202a is supported by an air bearing ball joint 242. The air bearing ball joint 242 has a round portion 244 supported within the float chuck 202a and an elongated portion 246 supported within a slide bearing 248. The air bearing ball joint 242 is designed such that air/gas can flow through it which enables the float chuck 202a to have 2 axes of movement. The ball portion 244 would be located at the center of mass of float chuck 202a. And, the slide bearing 248 is designed to enable the float chuck 202a and the air bearing ball joint 242 to have translation movement. It should be appreciated that the air bearing ball joint 242 could be connected to the gas heater/gas controller 206 to convey gas to the float chuck 202a.

As shown in FIGS. 20-2P, there are respectively illustrated a top view and a side view of yet another embodiment of the stabilization device 102a where the float chuck 202 is attached to a gas heater/gas controller 206 which in turn is attached to both the gas supply unit 204 (not shown) and a moveable mount 250. The moveable mount 250 is designed to enable the float chuck 202 and gas heater/gas controller 206 to have three degrees of movement including two-tilt movements and one-translation movement. In this way, the float chuck 202 can self-align and remain parallel with the glass sheet 105 (not shown). As shown, the moveable mount 250 has a gimbal ring 252 which is attached to a gimbal arm 254 that wraps around two sides of the gas heater/gas controller 206. The gimbal arm 254 itself is supported by four support arms 256. Each support arm 256 is attached to a hanger link 258. The gimbal arm 254 also has an end connected to a dashpot/fine position adjuster 260 (e.g., spring restrictor 260). The moveable mount 250 also has an air/gas supply line 262. It should be noted that the entire moveable mount 250 including its housing 264 (which has some insulation 266) can be mounted on rails for gross movement in and out of position to engage the glass sheet 105 (not shown).

As shown in FIG. 2Q, there is illustrated yet another embodiment of the stabilization device 102a where an active control system 268 is used to control the flow of the gas from the gas supply unit 204. The active control system 268 includes a control unit 270 that interacts with and receives a signal from a sheet motion sensor 272 and based on that signal controls the operation of the gas supply unit 204 to control the flow of gas emitted from the float chuck 202. In particular, the control unit 270 determines what the flow rate of the gas emitted from the float chuck 202 needs to be in order to help stabilize/prevent the movement of the glass sheet 105. Although the float chuck 202 is shown attached to the static mount 203 (see FIG. 2A) it should be appreciated that it can be attached to any one of the previously shown mounts (e.g., moveable mount 250, adaptive mount 209, spring/damper mount 226). It should also be appreciated that the active control system 268 can be incorporated within any of the stabilization devices 102a shown in FIGS. 2A-2Q. Moreover, it should be appreciated that any embodiment of stabilization device 102a, 102b, 102c, 102d could be located within the FDM 140a.

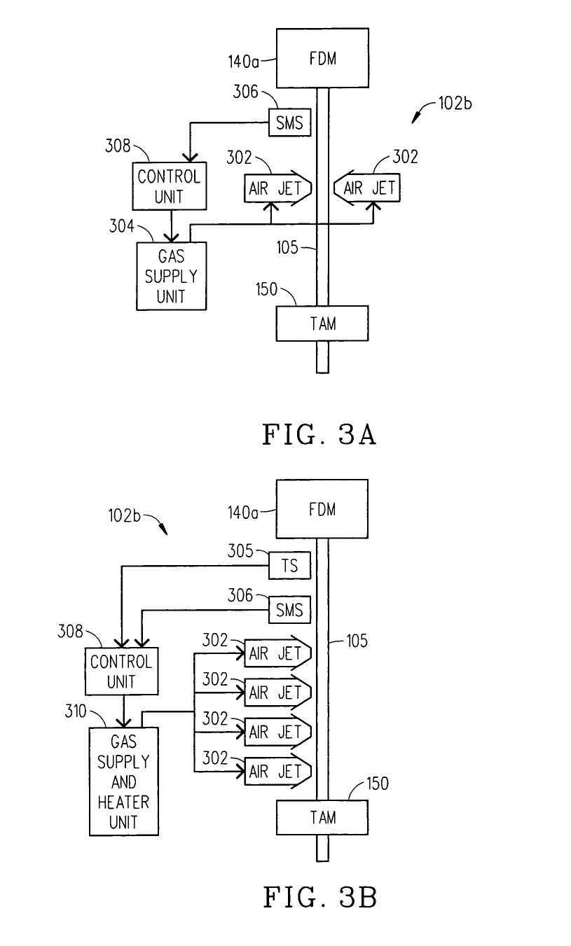

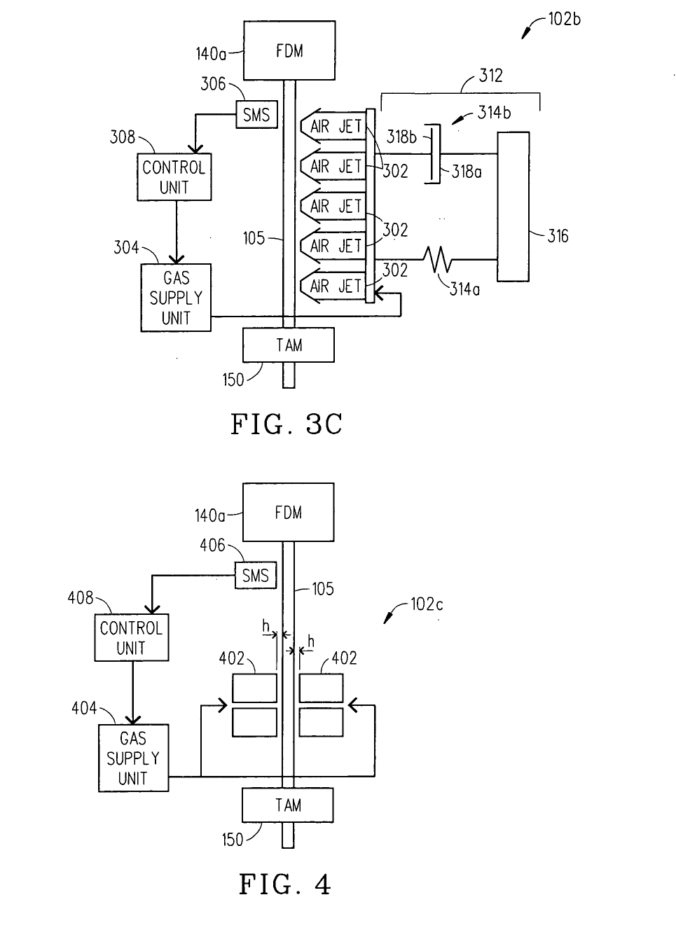

Referring to FIGS. 3A-3C, there are several diagrams associated with a second embodiment of the noncontact glass sheet stabilization device 102b which utilizes multiple air jets 302 to minimize the movement of the glass sheet 105 between the FDM 140a and the TAM 150. As shown in FIG. 3A, the stabilization device 102b includes two air jets 302, a gas supply unit 304, a sheet motion sensor 306 and a control unit 308. In operation, the control unit 308 interacts with and receives a signal from the sheet motion sensor 306 and based on that signal controls the operation of the gas supply unit 304 so that the proper amount of gas is emitted from the air jets 302. In particular, the control unit 308 interacts with the sheet motion sensor 306 and determines what the flow rate of the gas emitted from the air jets 302 needs to be in order to help stabilize/prevent the movement of the glass sheet 105. The air jets 302 affect the motion of the glass sheet 105 through the kinetic energy of the gas forced against the glass sheet 105. This kinetic energy of the gas is proportional to ρU², where ρ is the gas density and U is the gas velocity. The quantity ½ρU² is sometimes called “dynamic pressure”. Although one air jet 302 is shown located near each side of the glass sheet 105 and positioned between the FDM 140a and the TAM 150, it should be appreciated that multiple air jets 302 can be located near each side of the glass sheet 105 and positioned between the FDM 140a and the TAM 150. It should also be appreciated that the stabilization device 102b can incorporate a gas heater/gas controller that is similar in purpose to the one shown in FIG. 2G.

As shown in FIG. 3B, there is illustrated another embodiment of the stabilization device 102b where the control unit 308 interacts with a gas supply and heater unit 310 to control the flow rate and/or temperature of the gas flowing from multiple air jets 302 (only four shown). As described above, the control unit 308 interacts with the sheet motion sensor 306 and determines what the flow rate of the gas emitted from the air jets 302 needs to be in order to help stabilize/prevent the movement of the glass sheet 105. In the configuration shown in FIG. 3B, with air jets 302 on one side only of the sheet 105, it should be appreciated that the control unit 308 could call for airflow only when the sheet 105 is moving towards the air jets 302. In addition, the control unit 308 interacts with a temperature sensor 305 and controls the temperature of the gas emitted from the air jets 302. By controlling the temperature of the gas flowing from the air jets 302, one can control the shape of the glass sheet 105. This type of temperature control can be important since the glass sheet 105 can warp if it does not have a uniform temperature. In particular, if the glass sheet 105 is warped while it is in the FDM 140a before the glass sheet 105 has cooled to the annealing point then when the glass sheet 105 is at room temperature it will typically be both warped and stressed, so that an undesirable shape change results when the piece is trimmed or cut. As such, the temperature of the glass sheet 105 can be controlled with the temperature of the gas flowing from the air jets 302 to make the glass sheet 105 planar as it passes through the setting zone (where the shape of the glass sheet 105 “freezes”) within the FDM 140a and any subsequent bow or warp will be only temporary. Although the air jets 302 are shown located on one side of the glass sheet 105 and positioned between the FDM 140a and the TAM 150, it should be appreciated that the air jets 302 may be positioned within the FDM 140a. It should also be appreciated that the stabilization device 102b can use one or more air jets 302 located on one or both sides of the glass sheet 105. It should be further appreciated that the subsystem to control the temperature of the glass sheet 105 comprising the temperature sensor 305, control unit 308, and gas supply and heater unit 310 can be incorporated into any of the sheet stabilization systems 102b shown in FIGS. 3A-3C.

As shown in FIG. 3C, there is illustrated yet another embodiment of the stabilization device 102b where the air jets 302 are supported by a spring/damper system 312. As described above, the stabilization device 102b includes multiple air jets 302 (only five shown on the same side of the sheet 105), the gas supply unit 304, the sheet motion sensor 306 and the control unit 308. The spring/damper system 312 includes a spring 314a which is attached at one end to the air jets 302 and at another end to a static mount 316. In addition, the spring/damper system 312 includes a damper 314b (dashpot 314b) that has a fixed part 318a which is attached to the static mount 316 and a moveable part 318b which is attached to the airjets 302. In operation, the spring/damper system 312 helps “dampen” the motion of the glass sheet 105 rather than “constrain” the motion of the glass sheet 105. In this configuration, the control unit 308 can statically or dynamically control the velocity of gas flowing from the air jets 302 based on the position and motion of the glass sheet 105 so that the gas force is out-of-phase with the sheet motion which dampens the motion of the glass sheet 105. And, the spring/damper system 312 allows for additional dampening of the glass sheet 105 as needed. It should be appreciated that this stabilization device 102b can incorporate a gas heater/gas controller that is similar to the one shown in FIG. 2G. It should also be appreciated that each air jet 302 could be mounted on its own, independent spring/damper system 312 and air jets 302 on multiple spring/damper systems 312 could be placed on both sides of the glass sheet 105.

Referring to FIG. 4, there is shown a diagram of a third embodiment of the noncontact glass sheet stabilization device 102c which utilizes multiple air bearings 402 to minimize the movement of the glass sheet 105 between the FDM 140a and the TAM 150. As shown in FIG. 4, the stabilization device 102c includes two air bearings 402, a gas supply unit 404, a sheet motion sensor 406 and a control unit 408. In operation, the control unit 408 interacts with and receives a signal from the sheet motion sensor 406 and based on that signal controls the operation of the gas supply unit 404 so that the proper amount of gas is emitted from the air bearings 402. In particular, the control unit 408 interacts with the sheet motion sensor 406 and determines what the flow rate of the gas emitted from the air bearings 402 needs to be in order to help stabilize/prevent the movement of the glass sheet 105. The air bearings 402 work by generating a “lubrication pressure” within a small gap h between the glass sheet 105 and each air bearing 402. In this embodiment, the pressure on the glass sheet 105 depends on the viscosity of the gas μ and the size of the gap h and the lubrication pressure which is developed that is proportional to

$$\frac{μ U}{h} .$$

Although one air bearing 402 is shown located near each side of the glass sheet 105 and positioned between the FDM 140a and the TAM 150, it should be appreciated that multiple air bearings 402 can be located near each side of the glass sheet 105 and positioned between the FDM 140a and the TAM 150. It should also be appreciated that the stabilization device 102c can incorporate a gas heater/gas controller that is similar to the one shown in FIG. 2I. It should be appreciated that sheet stabilization device 102c could be operated in passive mode without the sheet motion sensor 406 and the control unit 408 so long as gas supply unit 404 was adjusted to provide the correct flowrate and pressure of gas.

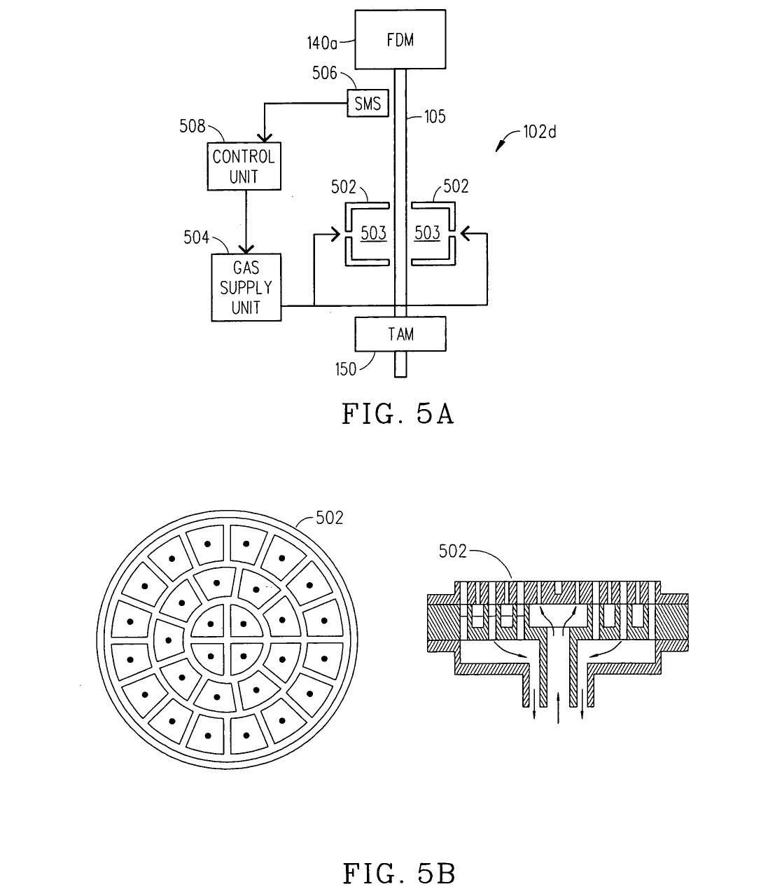

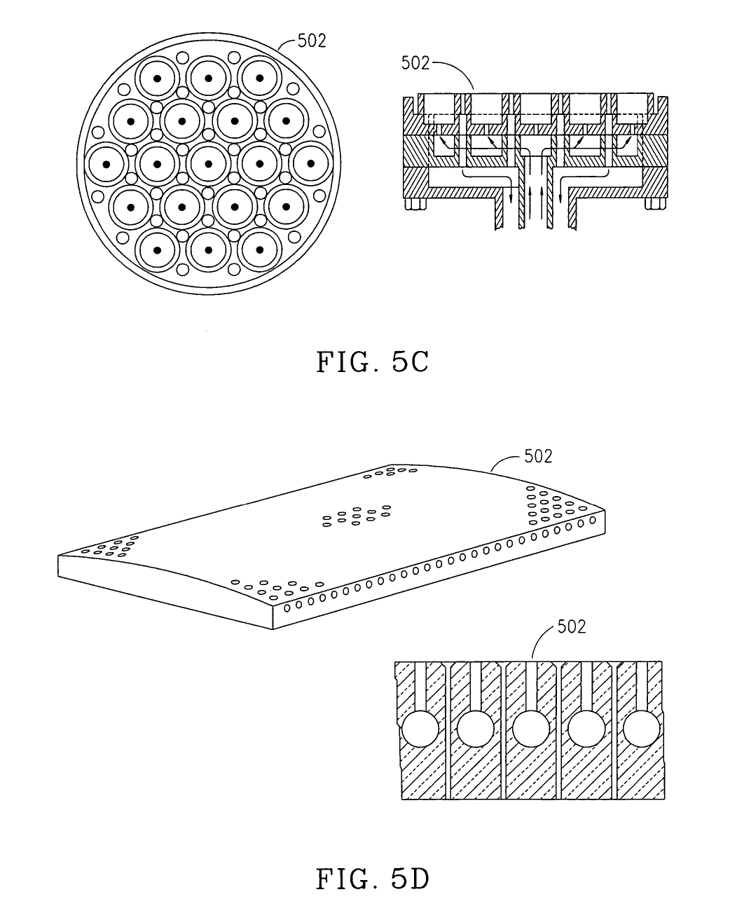

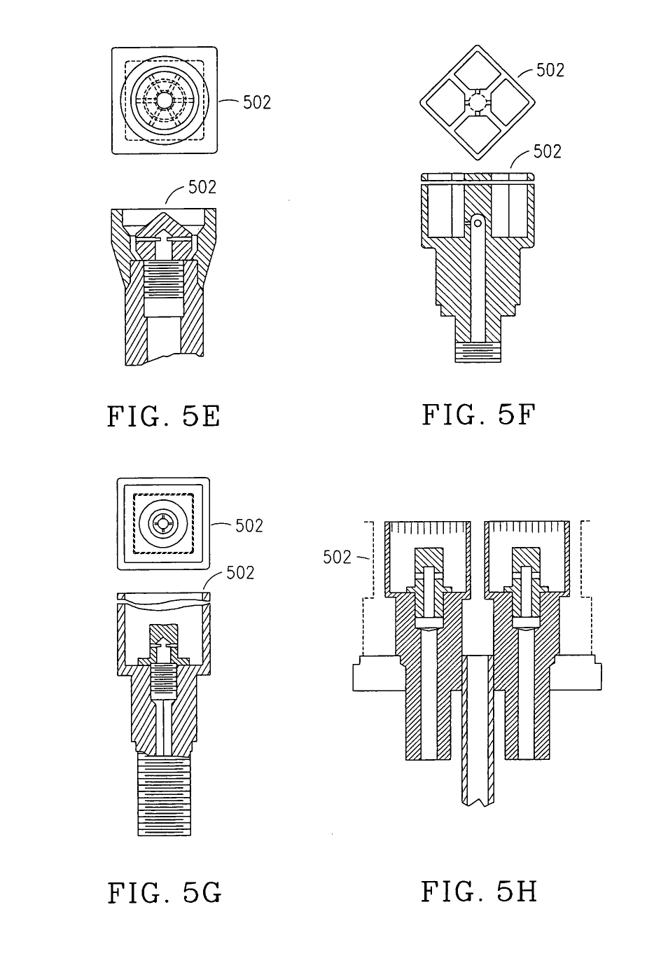

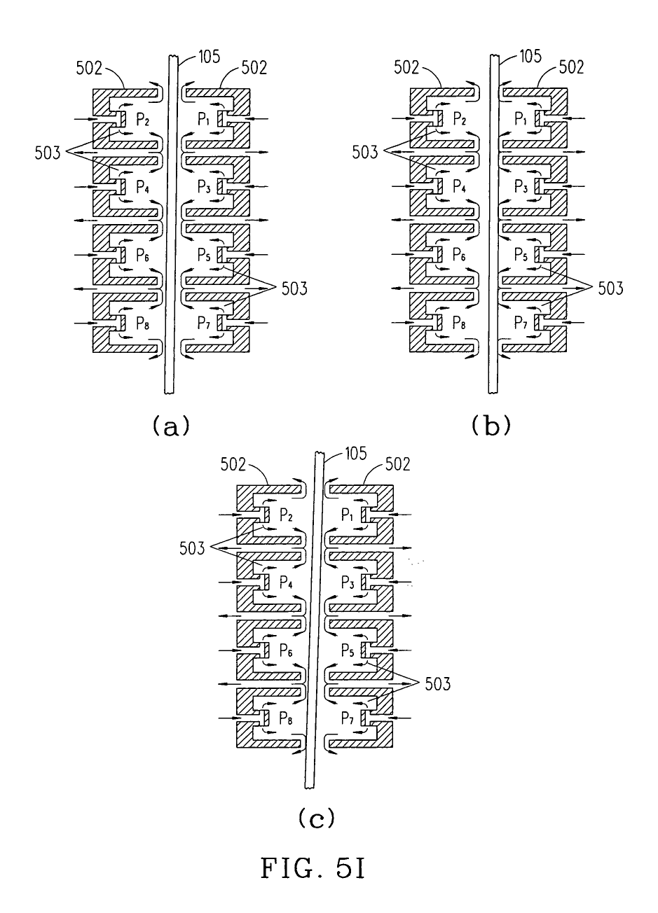

Referring to FIGS. 5A-5I, there are several diagrams associated with a fourth embodiment of the stabilization device 102d which utilizes multiple air cushions/pads 502 to minimize the movement of the glass sheet 105 between the FDM 140a and the TAM 150. As shown in FIG. 5A, the stabilization device 102d includes two air cushions/pads 502, a gas supply unit 504, a sheet motion sensor 506 and a control unit 508. In operation, the control unit 508 interacts with and receives a signal from the sheet motion sensor 506 and based on that signal controls the operation of the gas supply unit 504 so that the proper amount of gas is emitted from the air cushions/pads 502. In particular, the control unit 508 interacts with the sheet motion sensor 506 and determines what the flow rate of the gas emitted from each air cushion/pad 502 needs to be in order to help stabilize/prevent the movement of the glass sheet 105. The air cushion/pad 502 works by generating a “static pressure” in a cavity which pushes against the glass sheet 105. The force on the glass sheet 105 comes not from the impinging gas entering the cavity 503 or the lubrication forces around the edge of the glass sheet 105 but from the static pressure in the cavity 503. The total force is the static pressure P times the area of the cavity 503 in contact with the glass sheet 105. Although one air cushion/pad 502 is shown located near each side of the glass sheet 105 and positioned between the FDM 140 and the TAM 150, it should be appreciated that one or more air cushions/pads 502 can be located near one or more sides of the glass sheet 105. It should also be appreciated that the stabilization device 102d can incorporate a gas heater/gas controller that is similar to the one shown in FIG. 21.

FIGS. 5B-5I illustrate several exemplary configurations of air cushions/pads 502 that can be used in the stabilization device 102d. The opposing air cushions/pads 502 have a design that enables them to keep the glass sheet 105 centered between them on films of gas. As shown in FIG. 5I, there are three schematics “a-c” where multiple air cushions/pads 502 are placed one both sides of the glass sheet 105. Each air cushion/pad 502 could be held against the glass sheet 105 in a fixed position against a stop (not shown) so it could move away from the glass sheet 105 if the force from the glass sheet 105 exceeds that required to cause the glass sheet 105 to scrape on the air cushion/pad 502. As shown in schematic “b” of FIG. 5I when the glass sheet moves off center the air pressure from the nearest air cushion/pad 502 (right) increases and the air pressure from the opposing air cushion/pad 502 (left) decreases causing an unbalanced force tending to return the glass sheet 105 to a central position shown in schematic “a” of FIG. 51. When the glass sheet 105 centered as shown in schematic “a” of FIG. 5I, then the gap from the glass sheet 105 to the edge of the air cushions/pads 502 is constant. The air pressure drop thru this flow restriction would be the same if the air supply pressure is constant to both sides. Consequently the air pressure in the cups 503 would be equal which would make the force on the glass sheet 105 equal on both sides. As shown in schematic “c” of FIG. 5I it can be seen that a rotary motion of the glass sheet 105 can be resisted if P1 becomes greater than P2 and P8 becomes greater than P7 thus creating a moment that would tend to rotate the glass sheet 105 back to a central position. Although the air cushions/pads 502 have cup designs it should be noted that other designs would function in a similar manner. It should be appreciated that the air cushion/pad 502 shown in FIG. 5D is described in more detail in U.S. Pat. No. 3,332,759, And, the air cushions/pads 502 shown in FIGS. 5E-5H are described in more detail in U.S. Pat. No. 3,293,015. The contents of these two patents are incorporated by reference herein.

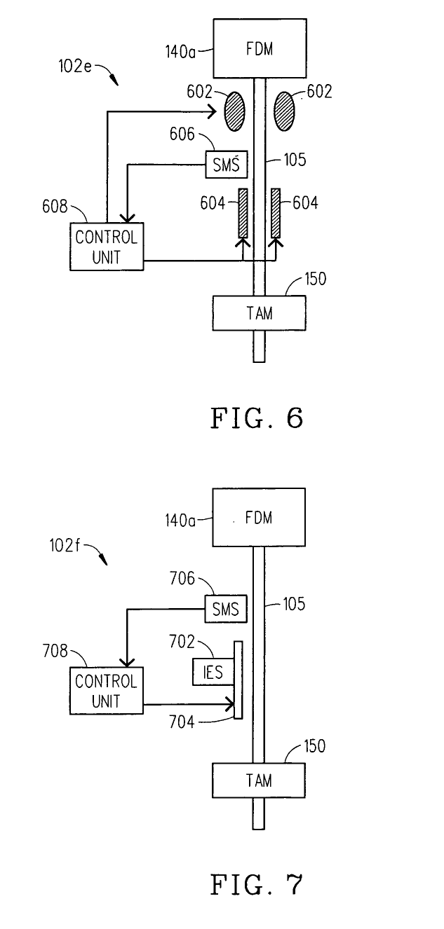

Referring to FIG. 6, there is shown a diagram of a fifth embodiment of the noncontact glass sheet stabilization device 102e which utilizes one or more corona charging device(s) 602 and chargeable plate(s) 604 to minimize the movement of the glass sheet 105 between the FDM 140a and the TAM 150. As shown in FIG. 6, the stabilization device 102e includes two corona charging devices 602, two chargeable plates 604, a sheet motion sensor 606 and a control unit 608. In operation, the control unit 608 interacts with and receives a signal from the sheet motion sensor 606 and based on that signal controls the operation of the corona charging devices 602 and/or the chargeable plates 604. In particular, the control unit 608 interacts with the sheet motion sensor 606 and controls the charge emitted from the corona charging devices 602 and deposited onto the glass sheet 105 and/or the charge on the chargeable plates 604 and/or the position of the chargeable plates 604 in order to help stabilize/prevent the movement of the glass sheet 105. In particular, the corona charging devices 602 apply an electrostatic charge directly to the glass sheet 105. After the glass sheet 105 is charged, it can be guided by the chargeable plates 604 (e.g., metal plates 604) whose charge and or position is controlled by the control unit 608. For example, the glass sheet 105 can be charged negatively and guided between negatively charged plates 604 which will repulse the glass sheet 105 if it gets too close to any one of the charged plates 604. Although two corona charging devices 602 and two chargeable plates 604 are shown located on opposite sides of the glass sheet 105 and positioned between the FDM 140a and the TAM 150, it should be appreciated that the corona charging devices 602 and chargeable plates 604 may be positioned within the FDM 140a. It should also be appreciated that the stabilization device 102e can also use one or more corona charging devices 602 and one or more chargeable plates 604 located on one or both sides of the glass sheet 105.

Referring to FIG. 7, there is shown a diagram of a sixth embodiment of the noncontact glass sheet stabilization device 102f which utilizes an induced electrostatic stabilizer (IES) 702 to minimize the movement of the glass sheet 105 between the FDM 140a and the TAM 150. As shown in FIG. 7, the stabilization device 102f includes the IES 702, a sheet motion sensor 706 and a control unit 708. The IES 702 includes a chargeable plate 704 with one or more regions that can be charged with different strengths and polarities. In operation, the control unit 708 interacts with and receives a signal from the sheet motion sensor 706 and based on that signal controls the IES 702. In particular, the control unit 708 interacts with the sheet motion sensor 706 and controls the magnitude of the electrostatic charge induced in the glass sheet 105 by the IES 702 in order to help stabilize/prevent the movement of the glass sheet 105. In particular, if a charged plate 704 is brought close to the glass sheet 105 it will actually induce the movement of electrons in the glass sheet 105 so it will have a charge on its surface. Even though the glass sheet 105 is a dielectric and conducts very poorly, it will be affected as a charged plate 704 is brought close to its surface. And, by using a charged plate 704 with alternating regions of positive and negative charges, an induced electrostatic charge on the glass sheet 105 can be generated and then forces can be applied to stabilize the glass sheet 105. For a more detailed description about induced electrostatic stabilizers in general reference is made to the following documents:

Ju Jin and Toshiro Higuchi, “Direct Electrostatic Levitation and Propulsion”, IEEE Transactions on Industrial Electronics, Vol. 44 No. 2 Apr. 1997, pp. 234-239.

Jong Up Jeon and Toshiro Higuchi, “Electrostatic Suspension of Dielectrics”, IEEE Transactions on Industrial Electronics, Vol. 45 No. 6 Dec. 1998, pp. 938-946.

The contents of these documents are hereby incorporated by reference herein.

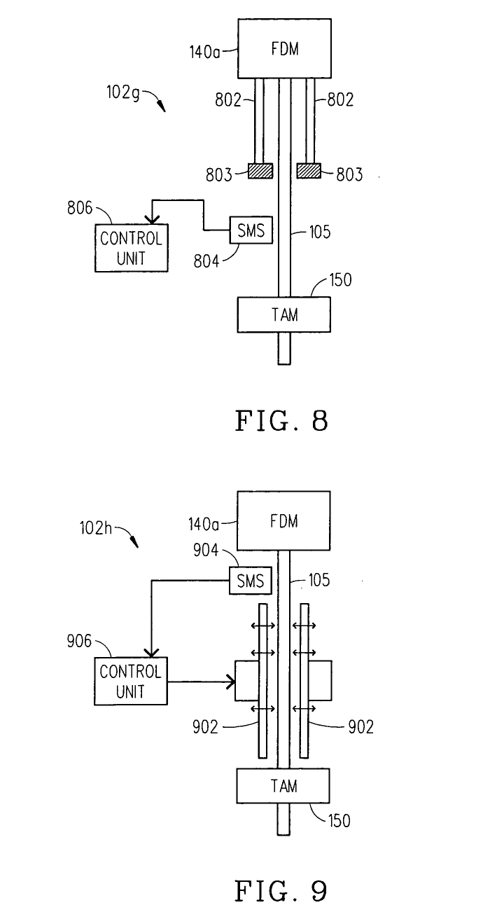

Referring to FIG. 8, there is shown a diagram of a seventh embodiment of the noncontact glass sheet stabilization device 102g which utilizes at least one wall 802 (two shown) that has an air inlet valve 803 to minimize the movement of the glass sheet 105 between the FDM 140a and the TAM 150. As shown in FIG. 8, the stabilization device 102g includes two walls 802, two air inlet valves 803, a sheet motion sensor 804 and a control unit 806. In operation, the control unit 806 interacts with and receives a signal from the sheet motion sensor 804 and based on that signal controls the air inlet valves 803 to help stabilize/prevent the movement of the glass sheet 105. In particular, the control unit 806 interacts with the sheet motion sensor 804 and controls the air inlet valves 803 which are located on the bottoms of the walls 802 (e.g., low permeability walls 802) to increase or decrease the sizes of openings between the glass sheet 105 and the air inlet valves 803. The sizes of these openings affect the amount of air that is drawn into the FDM 140a by the chimney effect which in turn affects the relative pressure on both sides of the glass sheet 105 in a manner that if controlled can help stabilize/prevent the movement of the glass sheet 105. Although each wall 802 is shown with its own air inlet valve 802, it should be appreciated that only one of the walls 802 may need an air inlet valve 803. It should also be appreciated that the control unit 806 can also control the position of each the plates 802 relative to the glass sheet 105 and can even tilt the plates 802 if needed to help stabilize/prevent the movement of the glass sheet 105.

Referring to FIG. 9, there is shown a diagram of an eighth embodiment of the noncontact glass sheet stabilization device 102h which utilizes one or more moveable plates 902 (two shown) to minimize the movement of the glass sheet 105 between the FDM 140a and the TAM 150. As shown in FIG. 9, the stabilization device 102h includes two moveable plates 902, a sheet motion sensor 904 and a control unit 906. In operation, the control unit 906 interacts with and receives a signal from the sheet motion sensor 904 and based on that signal controls the motion of the moveable plates 902 relative to the motion of the glass sheet 105 in order to help stabilize/minimize the movement of the glass sheet 105. In particular, the control unit 906 interacts with the sheet motion sensor 904 and dynamically controls the position and motion of the moveable plates 902 so that the force exerted by the moveable plates 902 on the glass sheet 105 is “out of phase” with the motion of the glass sheet 105 in order to dampen-out the motion of the glass sheet 105. This is possible because the gap between each moveable plate 902 and the glass sheet 105 is small which creates a vacuum or pressure force as the moveable plates 902 move which can reduce the motion of the glass sheet 105. Although one moveable plate 902 is shown on each side of the glass sheet 105, it should be appreciated that only one moveable plate 902 may be needed on one of the sides of the glass sheet 105. It should also be appreciated that the moveable plate(s) 902 may be located within the FDM 140a.

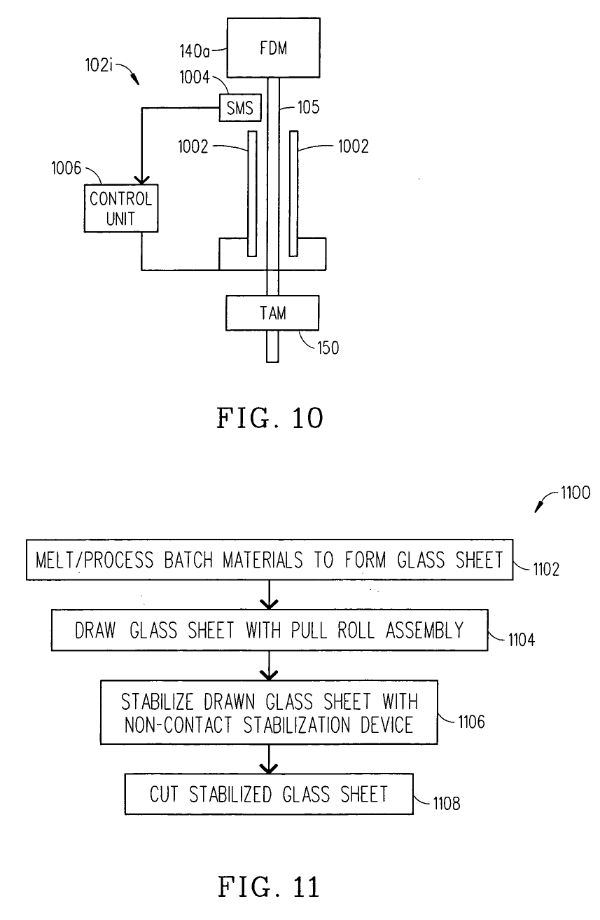

Referring to FIG. 10, there is shown a diagram of a ninth embodiment of the noncontact glass sheet stabilization device 102i which utilizes one or more thermally controlled plates 1002 to minimize the movement of the glass sheet 105 between the FDM 140a and the TAM 150. As shown in FIG. 10, the stabilization device 102i includes two thermally controlled plates 1002, a sheet motion sensor 1004 and a control unit 1006. In operation, the control unit 1006 interacts with and receives a signal from the sheet motion sensor 1004 and based on that signal controls the temperature T(x,y) of the thermally controlled plates 1002 in order to help stabilize the position of the glass sheet 105. It should be appreciated that the stabilization device 102i can also be used to affect the shape or bow of the glass sheet 105.

Referring to FIG. 11, is a flowchart illustrating the basic steps of a preferred method 1100 for producing a glass sheet using anyone of the aforementioned noncontact glass sheet stabilization devices 102. Beginning at step 1102, the glass manufacturing system 1100 is used to melt batch materials and process the molten batch material to form the glass sheet 105 which is then delivered to the FDM 140 (see FIG. 1). At step 1104, the glass sheet 105 is then drawn between two rolls of the pull roll assembly 140 in the FDM 140a (see FIG. 1). At step 1106, the stabilization device 102 is used to stabilize the glass sheet 105 that is output from the FDM 140a by reducing translation and/or rotational motion of the glass sheet 105 without physically contacting the glass sheet 105. Than at step 1108, the stabilized glass sheet 105 is cut by the TAM 150 (see FIG. 1). It should be appreciated that the stabilization device 102 also functions to help prevent the motion of the glass sheet 105 as the TAM 150 operates to cut the glass sheet 105. It should also be appreciated that any stabilization device utilized in step 1106 could be located partially or entirely within the FDM 140a as well as below the FDM 140a.

From the foregoing, it can be readily appreciated by those skilled in the art that the stabilization device 102 functions to stabilize the glass sheet 105 during draw so as to maintain a more constant manufacturing process. It should also be appreciated by those skilled in the art that the ideal non-contact sheet stabilization approach is a stable, passive one, which naturally generates restoring forces as the glass sheet 105 shifts from position, moving it back on target. However, it may be necessary to use an active control approach, where the position of the glass sheet 105 is monitored and the set-point in the stabilization device 102 is adjusted based on that measurement. In these approaches, it may even be necessary to use more than one sheet motion sensor even though only one of these sensors was shown and described herein.

It should be noted that one of the benefits of the non-contact stabilization device of the present invention is that it reduces sheet motion in the middle and upper levels of the FDM which results in a more consistent shape and lower and more stable stress levels in the cut glass sheet. Moreover, it should also be appreciated that another benefit of the non-contact stabilization device of the present invention is that it will reduce the movement of the glass sheet at the point where the glass sheet is scored and removed. This reduced motion allows for better performance of the scoring and subsequent steps of the sheet separation process by enabling more consistent score lines, more consistent crack propagation in the snap-off process and less sheet breakage.

It should be noted that although in the exemplary cases described above the noncontact stabilization device 102 is located between the FDM 140a and the TAM 150, it could also be located within the FDM 140a either above or below the pull roll assembly 140 so long as the glass sheet 105 has entered the elastic range of material properties. It should also be noted that the noncontact stabilization device 102 could be used in any application where minimal sheet motion (and thus a minimal range of locations of the sheet) is required. In addition, the noncontact stabilization device 102 can be used to alter the shape of the glass sheet 105 by for example placing multiple float chucks 202 across the width of the glass sheet 105 to reduce the lateral bow across the glass sheet 105 at the TAM 150. Each multiple float chuck 202 can have an independent suspension.

Although several embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. A noncontact glass sheet stabilization device that reduces the movement of a glass sheet without physically contacting the glass sheet while the glass sheet is being manufactured in accordance with a fusion process.

2. The noncontact glass sheet stabilization device of claim 1, wherein the movement that is reduced is translation movement, rotational movement or translation/rotational movement.

3. The noncontact glass sheet stabilization device of claim 1, wherein said device includes:
a gas supply unit; and
an aero-mechanical device through which gas from said gas supply unit flows so as to create a gas film on one side of the glass sheet such that if the glass sheet moves too far away from a face of said aero-mechanical device then a Bernoulli suction force caused by the gas emitted from said aero-mechanical device pulls the glass sheet closer to said aero-mechanical device and if the glass sheet moves too close to said aero-mechanical device then a repulsive force caused by the gas emitted from said aero-mechanical device pushes the glass sheet away from said aero-mechanical device.

4. The noncontact glass sheet stabilization device of claim 3, wherein said device further includes:
an adaptive mount coupled to said aero-mechanical device which enables said aero-mechanical device to have three degrees of movement including two-tilt movements and one-translation movement so that said aero-mechanical device can self-align with the glass sheet.

5. The noncontact glass sheet stabilization device of claim 3, wherein said device further includes:
a mount including a spring and a damper that are coupled to said aero-mechanical device.

6. The noncontact glass sheet stabilization device of claim 3, wherein said device further includes:
a mount including a flexible coupling that is coupled to said aero-mechanical device.

7. The noncontact glass sheet stabilization device of claim 3, wherein said device further includes:
a mount including a spherical joint that is coupled to said aero-mechanical device.

8. The noncontact glass sheet stabilization device of claim 3, wherein said device further includes:
a mount including an air bearing ball joint integral to the aero-mechanical device that enables the rotational and/or translational movement of said aero-mechanical device.

9. The noncontact glass sheet stabilization device of claim 3, wherein said device further includes:
a heat controller; and
a gas heater controlled by said heat controller to regulate the temperature of the gas emitted from said gas supply unit to said aero-mechanical device.

10. The noncontact glass sheet stabilization device of claim 1, wherein said device further includes:
a gas supply unit;
a first air jet located near a first side of the glass sheet;
a second air jet located near a second side of the glass sheet;
a sheet motion sensor that detects movement of the glass sheet; and
a control unit that interacts with said sheet motion sensor to control the flow of the gas emitted from said gas supply unit to said first air jet and to control the flow of the gas emitted from said gas supply unit to said second air jet.

11. The noncontact glass sheet stabilization device of claim 1, wherein said device further includes:
a gas supply unit;
a gas heater/cooler unit;
a plurality of air jets located near a first side of the glass sheet;
a sheet motion sensor that detects movement of the glass sheet;
a control unit that interacts with said sheet motion sensor to control the flow of the gas emitted from said gas supply unit to said plurality of air jets; and
said control unit further interacts with said gas heater/cooler unit to heat/cool the gas emitted from said gas supply unit to said plurality of air jets.

12. The noncontact glass sheet stabilization device of claim 1, wherein said device further includes:
a gas supply unit;
a plurality of air jets located near a first side of the glass sheet;
a mount including a spring and a damper coupled to said plurality of air jets;
a sheet motion sensor that detects movement of the glass sheet;
a control unit that interacts with said sheet motion sensor to control the flow of the gas emitted from said gas supply unit to said plurality of air jets.

13. The noncontact glass sheet stabilization device of claim 1, wherein said device further includes:
a gas supply unit;
a first air bearing located near a first side of the glass sheet;
a second air bearing located near a second side of the glass sheet;
a sheet motion sensor that detects movement of the glass sheet; and
a control unit that interacts with said sheet motion sensor to control the flow of the gas emitted from said gas supply unit to said first air bearing and to control the flow of the gas emitted from said gas supply unit to said second air bearing.

14. The noncontact glass sheet stabilization device of claim 1, wherein said device further includes:
a gas supply unit;
a first air cushion located near a first side of the glass sheet;
a second air cushion located near a second side of the glass sheet;
a sheet motion sensor that detects movement of the glass sheet; and
a control unit that interacts with said sheet motion sensor to control the flow of the gas emitted from said gas supply unit to said first air cushion and to control the flow of the gas emitted from said gas supply unit to said second air cushion.

15. The noncontact glass sheet stabilization device of claim 1, wherein said device further includes:
a corona charging device located near a first side of the glass sheet;
a charge plate located near the first side of the glass sheet;
a sheet motion sensor that detects movement of the glass sheet; and
a control unit that interacts with said sheet motion sensor to control a charge from said corona charging device and/or to control a charge from said charge plate and/or to control a position of said charge plate related to the first side of the glass sheet.

16. The noncontact glass sheet stabilization device of claim 1, wherein said device further includes:
an induced electrostatic stabilizer located near the first side of the glass sheet;
a sheet motion sensor that detects movement of the glass sheet; and
a control unit that interacts with said sheet motion sensor to control said induced electrostatic stabilizer.

17. The noncontact glass sheet stabilization device of claim 1, wherein said device further includes:
a thermally controlled plate;
a sheet motion sensor that detects movement of the glass sheet; and
a control unit that interacts with said sheet motion sensor to control the temperature T(x,y) of said thermally controlled plate.

18. The noncontact glass sheet stabilization device of claim 1, wherein said device further includes:
a pair of plates attached to a bottom of a fusion draw machine and located on opposing sides of the glass sheet emitted from the fusion draw machine;
an air inlet valve attached to a bottom of one of said plates;
a control unit that interacts with said air inlet valve to control the amount of air drawn into the fusion draw machine to affect the relative pressure on both sides of the glass sheet to help prevent the movement of the glass sheet.

19. The noncontact glass sheet stabilization device of claim 1, wherein said device further includes:
a plate located near a first side of the glass sheet;
a sheet motion sensor that detects movement of the glass sheet;
a control unit that interacts with said sheet motion sensor to control the position and movement of said plate.

20. A method for producing a glass sheet, said method comprising the steps of:
melting batch materials to form molten glass and processing the molten glass to form the glass sheet;
drawing the glass sheet using a fusion draw machine;
stabilizing the glass sheet using a noncontact glass sheet stabilization device which reduces movement of the glass sheet without physically contacting the glass sheet; and
cutting the glass sheet using a traveling anvil machine.

21. The method of claim 20, wherein said noncontact glass sheet stabilization device includes:
a gas supply unit; and
an aero-mechanical device through which gas from said gas supply unit flows so as to create a gas film on one side of the glass sheet such that if the glass sheet moves too far away from a face of said aero-mechanical device then Bernoulli suction caused by the gas emitted from said aero-mechanical device pulls the glass sheet closer to said aero-mechanical device and if the glass sheet moves too close to said aero-mechanical device then a repulsive force caused by the gas emitted from said aero-mechanical device pushes the glass sheet away from said aero-mechanical device.

22. The method of claim 21, wherein said noncontact glass sheet stabilization device further includes:
an adaptive mount coupled to said aero-mechanical device which enables said aero-mechanical device to have three degrees of movement including two-tilt movements and one-translation movement so that said aero-mechanical device can self-align with the glass sheet.

23. The method of claim 21, wherein said noncontact glass sheet stabilization device further includes:
a sheet motion sensor that detects movement of the glass sheet; and
a control unit that interacts with said sheet motion sensor to control the flow of the gas emitted from said gas supply unit to said aero-mechanical device.

24. The method of claim 21, wherein said noncontact glass sheet stabilization device further includes:
a heat controller; and
a gas heater controlled by said heat controller to heat the gas emitted from said gas supply unit to said aero-mechanical device.

25. A glass manufacturing system comprising:
at least one vessel for melting batch materials and forming molten glass;
an isopipe for receiving the molten glass and forming a glass sheet;
a fusion draw machine for drawing the glass sheet;
a noncontact glass sheet stabilization device for stabilizing the glass sheet by reducing movement of the glass sheet without physically contacting the glass sheet; and
a traveling anvil machine for cutting the glass sheet.

26. The glass manufacturing system of claim 25, wherein said noncontact glass sheet stabilization device includes:
a gas supply unit; and
an aero-mechanical device through which gas from said gas supply unit flows so as to create a gas film on one side of the glass sheet such that if the glass sheet moves too far away from a face of said aero-mechanical device then a Bernoulli suction force caused by the gas emitted from said aero-mechanical device pulls the glass sheet closer to said aero-mechanical device and if the glass sheet moves too close to said aero-mechanical device then a repulsive force caused by the gas emitted from said aero-mechanical device pushes the glass sheet away from said aero-mechanical device.

27. The glass manufacturing system of claim 26, wherein said noncontact glass sheet stabilization device further includes:
an adaptive mount coupled to said aero-mechanical device which enables said aero-mechanical device to have three degrees of movement including two-tilt movements and one-translation movement so that said aero-mechanical device can self-align with the glass sheet.

28. The glass manufacturing system of claim 26, wherein said noncontact glass sheet stabilization device further includes:
a sheet motion sensor that detects movement of the glass sheet; and
a control unit that interacts with said sheet motion sensor to control the flow of the gas emitted from said gas supply unit to said aero-mechanical device.

29. The glass manufacturing system of claim 26, wherein said noncontact glass sheet stabilization device further includes:
a heat controller; and
a gas heater controlled by said heat controller to heat the gas emitted from said gas supply unit to said aero-mechanical device.

30. A glass sheet formed by a glass manufacturing system that includes:
at least one vessel for melting batch materials and forming molten glass;
an isopipe for receiving the molten glass and forming the glass sheet;
a fusion draw machine for drawing the glass sheet;
a noncontact glass sheet stabilization device for stabilizing the glass sheet by reducing movement of the glass sheet without physically contacting the glass sheet; and
a traveling anvil machine for cutting the glass sheet.

31. The glass sheet of claim 30, wherein said noncontact glass sheet stabilization device includes:
a gas supply unit; and
an aero-mechanical device through which gas from said gas supply unit flows so as to create a gas film on one side of the glass sheet such that if the glass sheet moves too far away from a face of said aero-mechanical device then a Bernoulli suction force caused by the gas emitted from said aero-mechanical device pulls the glass sheet closer to said aero-mechanical device and if the glass sheet moves too close to said aero-mechanical device then a repulsive force caused by the gas emitted from said aero-mechanical device pushes the glass sheet away from said aero-mechanical device.

32. The glass sheet of claim 31, wherein said noncontact glass sheet stabilization device further includes:
an adaptive mount coupled to said aero-mechanical device which enables said aero-mechanical device to have three degrees of movement including two-tilt movements and one-translation movement so that said aero-mechanical device can self-align with the glass sheet.

33. The glass sheet of claim 31, wherein said noncontact glass sheet stabilization device further includes:
a sheet motion sensor that detects movement of the glass sheet; and
a control unit that interacts with said sheet motion sensor to control the flow of the gas emitted from said gas supply unit to said aero-mechanical device.

34. The glass sheet of claim 31, wherein said noncontact glass sheet stabilization device further includes:
a heat controller; and
a gas heater controlled by said heat controller to heat the gas emitted from said gas supply unit to said aero-mechanical device.

35. A noncontact glass sheet stabilization device that reduces the movement of a glass sheet without physically contacting the glass sheet while the glass sheet is being manufactured in accordance with a fusion process wherein said noncontact glass sheet stabilization device includes:
a gas supply unit;
an aero-mechanical device through which gas from said gas supply unit flows so as to create a gas film on one side of the glass sheet such that if the glass sheet moves too far away from a face of said aero-mechanical device then a Bernoulli suction force caused by the gas emitted from said aero-mechanical device pulls the glass sheet closer to said aero-mechanical device and if the glass sheet moves too close to said aero-mechanical device then a repulsive force caused by the gas emitted from said aero-mechanical device pushes the glass sheet away from said aero-mechanical device;
an adaptive mount coupled to said aero-mechanical device which enables said aero-mechanical device to have three degrees of movement including two-tilt movements and one-translation movement so that said aero-mechanical device can self-align with the glass sheet;
a heat controller; and
a gas heater controlled by said heat controller to regulate the temperature of the gas emitted from said gas supply unit to said aero-mechanical device.

36. A noncontact glass sheet stabilization device that reduces the movement of a glass sheet without physically contacting the glass sheet while the glass sheet is being manufactured in accordance with a fusion process wherein said noncontact glass sheet stabilization device includes:
a gas supply unit;
an aero-mechanical device through which gas from said gas supply unit flows so as to create a gas film on one side of the glass sheet such that if the glass sheet moves too far away from a face of said aero-mechanical device then a Bernoulli suction force caused by the gas emitted from said aero-mechanical device pulls the glass sheet closer to said aero-mechanical device and if the glass sheet moves too close to said aero-mechanical device then a repulsive force caused by the gas emitted from said aero-mechanical device pushes the glass sheet away from said aero-mechanical device;
a mount including a spherical joint that is coupled to said aero-mechanical device;
a heat controller; and
a gas heater controlled by said heat controller to regulate the temperature of the gas emitted from said gas supply unit to said aero-mechanical device.

37. The noncontact glass sheet stabilization device of claim 36, wherein said device further includes:
a sheet motion sensor that detects movement of the glass sheet; and
a control unit that interacts with said sheet motion sensor to control the flow of the gas emitted from said gas supply unit to said aero-mechanical device.
